(19) United States
(12) Patent Application Publication
(10) Pub. No.: US 2005/0171826 A1
(43) Pub. Date: Aug. 4, 2005

(54) A METHOD FOR SUPPLY CHAIN DECOMPOSITION

(75) Inventors: Brian T. Denton, Winooski, VT (US); John J. Forrest, Peekskill, NY (US)

Correspondence Address: FREDERICK W. GIBB, III;MCGINN & GIBB, PLLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 10/707,977

(22) Filed: Jan. 29, 2004

(51) Int. Cl. G06F 17/60

(52) U.S. Cl. 705/8

(57) ABSTRACT

The invention provides a method and system for solving a linear program having constraints in a production planning system. The invention first determines which of the constraints can be temporarily relaxed based on stocking point criteria. The stocking point criteria relates to time dependent stocking points that include part numbers, locations of parts identified by the part numbers, and the time periods when the parts will be available. The invention relaxes the constraints that can be relaxed and decomposes the linear program into smaller independent linear programs. The invention initially solves the smaller independent linear programs with relaxed constraints (simultaneously in parallel) to produce an initial solution. Next, the invention replaces variables in the linear program with constants based on this initial solution. After this the invention restores the material balance and sourcing constraints and finally solves (re-solves) the linear program using the constants and with all constraints in place to obtain a complete solution of the linear program.

### CROSS REFERENCE TO RELATED APPLICATIONS

The present application is related to pending U.S. patent application Ser. No. 10/______, filed concurrently herewith to Denton et al., entitled “A Method for Supply Chain Compression” having (IBM) Docket No. BUR920030197US1; U.S. patent application Ser. No. 10/______, filed concurrently herewith to Denton et al., entitled “METHOD FOR PURCHASE ORDER RESCHEDULING IN A LINEAR PROGRAM” having (IBM) Docket No. BUR92004009US1; U.S. patent application Ser. No. 10/______, filed concurrently herewith to Denton et al., entitled “A METHOD FOR OPTIMIZING FOUNDRY CAPACITY” having (IBM) Docket No. BUR920030195US1; U.S. patent application Ser. No. 10/______, filed concurrently herewith to Denton et al., entitled “METHOD FOR FAIR SHARING LIMITED RESOURCES BETWEEN MULTIPLE CUSTOMERS” having (IBM) Docket No. BUR92004001OUS1; U.S. patent application Ser. No. 10/______, filed concurrently herewith to Denton et al., entitled “A METHOD FOR CONSIDERING HIERARCHICAL PREEMPTIVE DEMAND PRIORITIES IN A SUPPLY CHAIN OPTIMIZATION MODEL” having (IBM) Docket No. BUR920030198US1; U.S. patent application Ser. No. 10/______, filed concurrently herewith to Denton et al., entitled “Method for Simultaneously Considering Customer Commit Dates and Customer Request Dates” having (IBM) Docket No. BUR920040008US1; and U.S. patent application Ser. No. 10/______, filed concurrently herewith to Denton et al., entitled “METHOD FOR IDENTIFYING PRODUCT ASSETS IN A SUPPLY CHAIN USED TO SATISFY MULTIPLE CUSTOMER DEMANDS” having Docket No. BUR820030346US1. The foregoing applications are assigned to the present assignee, and are all incorporated herein by reference.

### BACKGROUND OF INVENTION

1. Field of the Invention

The present invention relates to computer implementable decision support systems for determining an optimal supply chain plan. General methodologies within this field of study include advanced planning systems, optimization and heuristic based algorithms, constraint based programming, and simulation.

2. Description of the Related Art

A fundamental problem faced in all manufacturing industries is the allocation of material and capacity assets to meet end customer demand. Production lead times necessitate the advance planning of production starts, inter-plant shipments, and material substitutions throughout the supply chain so that these decisions are coordinated with the end customers” demand for any of a wide range of finished products (typically on the order of thousands in semiconductor manufacturing). Such advance planning depends upon the availability of finite resources which include: finished goods inventory, work in process inventory (WIP) at various stages of the manufacturing system, and work-center capacity. Often, there are alternative possibilities for satisfying the demand. Products may be built at alternative locations and within a location there may be choices as to which materials or capacity to use to build the product. The product may be built directly or acquired through material substitution or purchase. When limited resources prevent the satisfaction of all demands, decisions need to be made as to which demand to satisfy and how to satisfy it. This resource allocation problem is often addressed through linear programming.

The below-referenced U.S. patents disclose embodiments that were satisfactory for the purposes for which they were intended. The disclosures of both the below-referenced prior U.S. patents, in their entireties, are hereby expressly incorporated by reference into the present invention for purposes including, but not limited to, indicating the background of the present invention and illustrating the state of the art: U.S. Pat. No. 5,971,585, “Best can do matching of assets with demand in microelectronics manufacturing,” Oct. 26, 1999; U.S. Pat. No. 5,943,484, “Advanced material requirements planning in microelectronics manufacturing,” Aug. 24, 1999; and Nemhauser, G. L. and Wolsey, L. A., 1999, Wiley, Integerand Combinatorial Optimization.

### SUMMARY OF INVENTION

The invention provides a method and system for solving a linear program having constraints in a production planning system. The invention first determines which of the constraints can be temporarily relaxed based on stocking point criteria. The stocking point criteria relates to time dependent stocking points that include part numbers, locations of parts identified by the part numbers, and the time periods when the parts will be available. The invention relaxes the constraints that can be relaxed and decomposes the linear program into smaller independent linear programs. The invention initially solves the smaller independent linear programs with relaxed constraints (simultaneously in parallel) to produce an initial solution. Next, the invention replaces variables in the linear program with constants based on this initial solution. After this, the invention restores the material balance and sourcing constraints and finally solves (re-solves) the linear program using the constants and with all constraints in place to obtain a complete solution of the linear program.

The process of determining which of the constraints can be temporarily relaxed identifies constraints that are associated with the least complex parts within bills-of-materials used by the linear program as the constraints that can be temporarily relaxed. Additionally, this process identifies constraints that are associated with parts that have supply availability and lack capacity constraints as the constraints that can be temporarily relaxed. Further, this process identifies constraints that are associated with parts that are available during the planning horizon of the linear program as the constraints that can be temporarily relaxed (the planning horizon includes an initial planning horizon, shipping lead time, and manufacturing cycle time).

### BRIEF DESCRIPTION OF DRAWINGS

FIG. 1: Overview of the structure of a linear programming application.

FIG. 2: Illustration of relaxation of material balance equations at the bottom of the bill-of-material and resulting potential for decomposition.

FIG. 3: Illustration of the flow of the present invention.

### DETAILED DESCRIPTION

Detailed Description of Preferred Embodiment(s) of the Invention The invention solves a supply-chain optimization model according to a two stage algorithm. Initially, a subset of material balance and sourcing constraint equations are relaxed to reduce the size of the linear program and also to increase the likelihood that it can be decomposed into multiple smaller linear programs. Next, the relaxed linear program is solved (via decomposition if possible) using an existing methodology (e.g., simplex method). The current solution is fixed, the previously relaxed constraints (and associated variables) are added back to the model, and the remaining (much smaller) model is solved to determine the final solution.

To contrast the present invention, a conventional production planning linear program “LP” is shown below (such as that described in U.S. Pat. No. 5,971,585, which is incorporated herein by reference). This LP makes decisions including: production starts, material substitutions, and shipments planned to customers, between manufacturing and distribution locations, and from vendor suppliers. A LP is composed of an objective function that defines a measure of the quality of a given solution, and a set of linear constraints. The types of equations used in production planning models are well know to those practiced in the art and include:(1) Material Balance Constraints, which ensure conservation of material flow through the network of stocking points comprising the supply chain.

(2) Capacity Constraints, which ensure that the capacity available for manufacturing activities is not exceeded.

(3) Backorder Conservation Constraints, which balance the quantity of a given part backordered in a given planning period with the quantity backordered in the previous planning period and the net of new demand and new shipments.

(4) Sourcing Constraints, which define target ranges (minimum and maximum) of shipments that should be made from a particular manufacturing or vendor location in the supply chain.

A conventional LP formulation is provided below in the form familiar to those practiced in the art; i.e., definition of subscripts, definition of objective function coefficients, definition of constants, definition of decision variables, LP formulation or equations.

Definition of Subscripts

j—time period

m—material (part number)

a—plant location within the enterprise

n material being substituted

z—group (which represents a family or collection of part numbers)

e process (a method of purchasing or manufacturing a material at a plant)v—receiving plant location

k demand center (i.e., customer location) (Note: the set of customer locations is mutuallyexclusive from the set of plant locations)

q—demand class which indicates relative priority

w—resource capacity which could be a machine, labor hour, or other constraint

u represents a consumer location which refers to an internal plant, external demand center, or toa generic indicator meaning any plant/or demand center

Definition of Objective Function Coefficients

PRCⱼₘₐₑ—cost of releasing one piece of part m during period j at plant a using process e

SUBC_{jmna—}substitution cost per piece of part number n which is being substituted by part number m during periodj at plant a

TCⱼₘₐᵥ—transportation cost per piece of part number m leaving plant a during period j which are destined for plant v

INVCⱼₘₐ—inventory cost of holding one piece of part number m at the end of period j at a particular plant a

DMAXC_{jzau}—cost per piece of exceeding the maximum amount of shipments of group z parts from plant a to consuming location(s) u during period j

DMINC_{jzau}—cost per piece of falling short of the minimum amount of shipments specified for group z parts from plant a to consuming location(s) u during period j

BOC_{jmkq}—backorder cost of one piece of part m at the end of period j for class q demand at customer location k

Definition of Constants

DEMAND_{jmkq}—demand requested during time period j for part number m at customer location k for demand class q

RECEIPTⱼₘₐ—quantity of projected wip and purchase order receipts for part number m expected to be received at plant a during time periodj

CAPACITY_{jaw}—Capacity of resource w available at plant a during period jto support production starts

CAPREQ_{jmaew}—Capacity of resource w required for part number m at plant a for process e during period j

QTYPERⱼₘₐₑₙ—quantity of component m needed per part number n during period j at plant a using process e

YIELDⱼₘₐₑ—output of part number m per piece released or started at plant a during time period j using process e

SUBQTYⱼₘₙₐ—quantity of part number m required to substitute for one piece of part number n at plant a during time period j

MAXPCT_{jzau}—maximum percentage of total shipments of group z (collection of parts) leaving supplier a during period j to support consumption at consuming location(s) u

MINPCT_{jzau}—minimum percentage of total shipments of group z (collection of parts) leaving supplier a during period j to support consumption at consuming location(s) u

CTⱼₘₐₑ—Cycle time. The number of periods between the release and completion of part m jobs for releases made using process e at plant a during time period j

TTₘₐᵥ—transport time for part number m from plant a to plant v

Definition of LP Decision Variables

Iⱼₘₐ—Inventory at the end of period j for part number m at a particular plant a

pⱼₘₐₑ—Production starts of part m during period j at plant a using process e

Lⱼₘₙₐ —Quantity of part number n which is being substituted by part number m during periodj at plant a

Tⱼₘₐᵥ—Internal shipments of part number m leaving plant a during period j which are destined for plant v

F_{jmakq}—Shipments of part number m leaving plant a during period j and satisfying class q demand at external customer k

B_{jmkq}—Back orders of part m at the end of period j for class q demand at customer location k

H_{jzu}—Total shipments of group z (z is a “collection” of parts) leaving suppliers during period j to support consumption at consuming location(s) u

S_{jzau}—Amount by which total shipments of parts in z from plant a to consuming location(s) u during period j exceeds the maximum amount specified as desired in the sourcing rules

G_{jzau}—Amount by which total shipments of group z parts from plant a to consuming location(s) u during period j falls short of the minimum amount specified as desired in the sourcing rules

LP Equations or Formulation Objective Function:

Minimize:

$${\sum }_{j} {\sum }_{m} {\sum }_{a} {\sum }_{e} {PRC}_{jmae} {P}_{jmae} + {\sum }_{j} {\sum }_{m} {\sum }_{n} {\sum }_{a} {SUBC}_{jmna} {L}_{jmna} + {\sum }_{j} {\sum }_{m} {\sum }_{a} {\sum }_{v} {TC}_{jmav} {T}_{jmav} + {\sum }_{j} {\sum }_{m} {\sum }_{a} {INVC}_{jma} {I}_{jma} + {\sum }_{j} {\sum }_{z} {\sum }_{a} {\sum }_{u} {DMAXC}_{jzau} {S}_{jzau} + {\sum }_{j} {\sum }_{z} {\sum }_{a} {\sum }_{u} {DMINC}_{jzau} {G}_{jzau} + {\sum }_{j} {\sum }_{m} {\sum }_{k} {\sum }_{q} {BOC}_{jmkq} {B}_{jmkq}$$

Subject to:

Sourcing Constraints:

$${H}_{jzu} = {\sum }_{{m}_{ɛz}} {\sum }_{a} ( {T}_{jmau} + {\sum }_{q} {F}_{jmauq} ) {\sum }_{{m}_{ɛz}} ( {T}_{jmau +} {\sum }_{q} {F}_{jmauq} ) - {S}_{jzau} \leq {MAXPCT}_{jzau} {H}_{jzu} {\sum }_{{m}_{ɛz}} ( {T}_{jmau} + {\sum }_{q} {F}_{jmauq} ) + {G}_{jzau} \geq {MINPCT}_{jzau} {H}_{jzu}$$

Capacity Constraints:

$${\sum }_{m} {\sum }_{e} {CAPREQ}_{jmaew} {P}_{jmae} \leq {CAPACITY}_{jaw}$$

Backorder Constraints:

$${B}_{jmkq} = {B}_{( j - 1 ) mkq} + {DEMAND}_{jmkq} - {\sum }_{a} {F}_{jmakq}$$

Material Balance Constraints:

$${I}_{jma} = {I}_{( j - 1 ) ma} + {RECEIPT}_{jma} + {{\sum }_{xsi . t}}_{x + CTxmae = j} {\sum }_{e} {YIELD}_{xmae} * {P}_{xmae} + {\sum }_{n} {L}_{jmna} + {\sum }_{{xs . t}_{x + TTmav = j}} {\sum }_{v} {T}_{xmva} - {\sum }_{n} {SUBQTY}_{jmna} * {L}_{jmna} - {\sum }_{v} {T}_{jmav} - {\sum }_{k} {\sum }_{q} {F}_{jmakq \\} - {{\sum }_{nst . m}}_{is a component \\ of n} {\sum }_{e} {QTYPER}_{jmaen} {P}_{jnae}$$

Non-Negativity Constraints:
all X_{i,j . . .} ≧0, where X is a generic decision variable and i, j etc. represent generic subscripts

In the supply chain linear programming model shown above, one problem that occurs is related to the need to improve runtime for large-scale production planning. Linear programming models that represent division level production planning problems typically have variables and constraint equations measured in millions. Such large-scale production planning problems can pose serious problems in terms of runtime. Some supply chain planning problems are naturally decomposable. For example, different manufactured parts may have independent bills-of-material. In these cases, supply chain models can be broken into multiple smaller independent linear programming models that can be solved much faster. However, many manufacturing industries assembly involve the use of common commodity components for multiple assemblies (e.g., mechanical parts such as motors, cables, controller cards). These commodity items tend to link otherwise independent product groups and inhibit decomposing the resulting linear program. Furthermore, when suppliers provide multiple commodity items there may be contracts in place that specify contractual purchasing obligations for the aggregate of parts. Thus, otherwise independent commodity items are linked by these contracts and similarly inhibit decomposition of the resulting linear program.

There are existing methods for decomposing general (not necessarily supply-chain) linear programming models which are loosely linked (e.g. Dantzig Wolf decomposition, Benders composition “Linear Programming and Extensions”, G. Dantzig). However, while these methods can improve runtimes they can be slow to converge and hence the improvements are often limited. The present method is an approach which uses a two stage linear programming method that specifically exploits the structure of supply-chain optimization models.

In many manufacturing industries (e.g., hard drives and servers in the computer industry) many components are used to build the final assembly, however, several of the components have unconstrained supply after some point in time (i.e., after the lead time required to obtain them). In a linear programming model of the supply-chain, these components act to prevent parallelization. The inventive decomposition method temporarily removes portions of the linear programming model (via relaxation of certain valid constraints) and solves a smaller relaxed version of the problem with improved runtime. By way of a two-stage algorithm (described below) certain constraints can be temporarily relaxed and then added back into the problem to obtain a solution to the complete model with a substantial improvement in runtime.

The invention provides substantial runtime improvement. Large-scale production planning problems such as those at the central division planning level can pose serious problems in terms of runtime. The faster the application is able to run, the larger the number of scenarios that planners are able to review in order to determine an optimal division build plan to commit. For some production models instances, the invention has resulted in order of magnitude improvements in runtime (e.g., for one production model it reduced runtime from 13,201 to 933 seconds on an IBM Regatta p690).

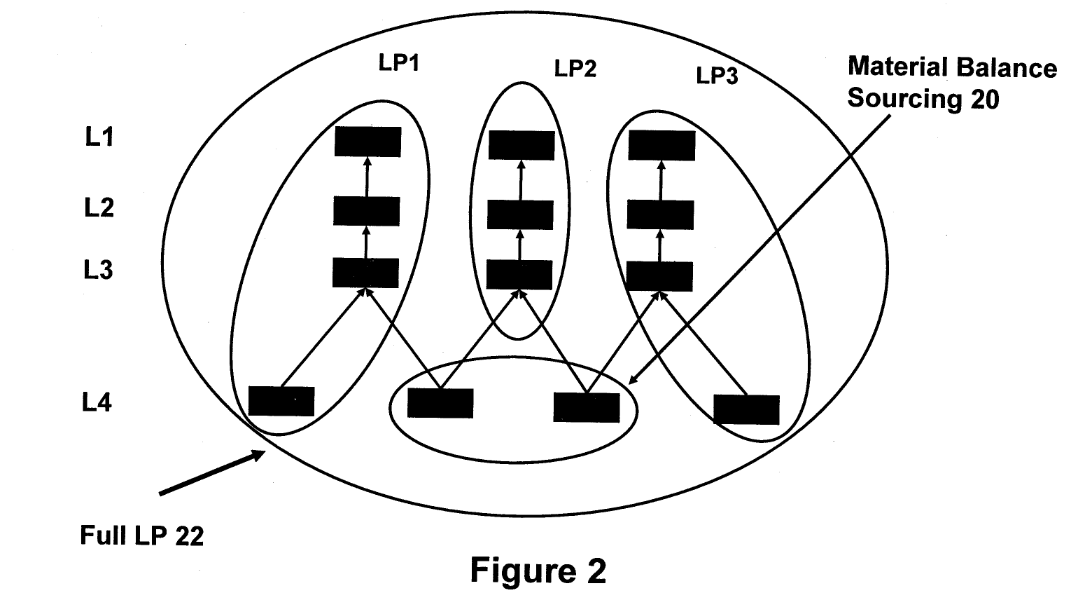

FIG. 2 provides a graphical illustration of the inventive method. FIG. 2 illustrates some simple bill-of-material (BOM) relationships in which assemblies, sub-assemblies etc. span four levels (L1-L4) of BOM and the overall linear program LP 22. Relaxation of material balance constraints and sourcing constraints for some of the L4 part numbers 20 results in a linear program that is separable into three parts, LP1, LP2, LP3, which can be solved in parallel. Once these individual linear programs are solved, the basic variables in LP1, LP2, and LP3 can be fixed. “Basic variables” is a term of art in the field of linear programming and describes those variables within the linear program model that are not set to zero as the linear program model is developed. Subsequently, the material balance constraints and sourcing constraints 20 relating to some BOM level L4 can be reinstated and the overall linear program can be solved (with most basic variables fixed) by leveraging the existing solution to the separable linear programs LP1, LP2, LP3.

The following steps outline in detail the above-described method for decomposing a large-scale linear programming model for a supply chain optimization problem. More specifically, in item 300 the invention evaluates “material balance” and “sourcing” constraints associated with time dependent stocking points (PN/PLANT/PERIOD combinations) to determine which ones can be temporarily relaxed. The stocking point criteria relates to time dependent stocking points that include part numbers, locations of parts identified by the part numbers, and the time periods when the parts will be available.

The “material balance” constraints relate to changes in inventory of a specific part number at a specific location over time and the “sourcing” constraints maintain diversity in the source from which component parts are obtained. While these two constraints are used in this invention, the invention could use other similar constraints in different types of linear programs. For example, the constraints could involve any of the following characteristics discussed below with respect to the criteria for choosing appropriate constraints.

The criteria for choosing appropriate stocking points that are associated with the material balance and sourcing constraints includes selecting stocking points from the bottom of the bill-of-material. The bottom of the bill-of-material maintains the least complex components such as raw materials, unassembled components, etc., while the upper levels of the bill of materials include more complex part numbers such as partially completed sub-assemblies or complete assemblies. An additional criterion is whether the part number (PN) availability at the plant location (PLANT) is constrained by capacity constraints (or similar constraints limiting availability). Another criterion is whether the parts are available during the entire planning horizon. In other words, the PERIOD should be greater than (initial planning horizon date+shipping lead time+manufacturing cycle time) and the PN should be able to be built (i.e., is not inhibited) throughout the entire planning horizon.

Thus, the invention identifies constraints that are associated with the least complex parts within bills-of-materials used by the linear program as the constraints that can be temporarily relaxed. Additionally, this process identifies constraints that are associated with parts that have supply availability and lack capacity constraints as the constraints that can be temporarily relaxed. Further, this process identifies constraints that are associated with parts that are available during the planning horizon of the linear program as the constraints that can be temporarily relaxed (the planning horizon includes an initial planning horizon, shipping lead time, and manufacturing cycle time).

In item 302 the invention relaxes the constraints that can be relaxed by setting the upper and lower bounds on the relaxable constraints to +infinity and infinity respectively. In item 304, the invention decomposes the resulting linear program 22, and solves the individual (smaller) linear programs (LP1-LP3) in parallel on a multi-processor high performance computing server (e.g., simplex method).

Next, in item 306, the invention replaces the basic variables in the linear programs solved in item 302 with constants. More specifically, this processing selectively sets the lower and upper bounds for “basic” variables to their current value as solved in item 302. As mentioned above, “basic variables” is a term of art in the field of linear programming and describes those variables within the linear program model that are not set to zero as the linear program model is developed. In item 308, the invention puts the constraints relaxed in item 302 back into the linear program model and, in item 310, the invention solves the linear program (with the basic variables fixed in item 306) to determine the solution to the complete problem.

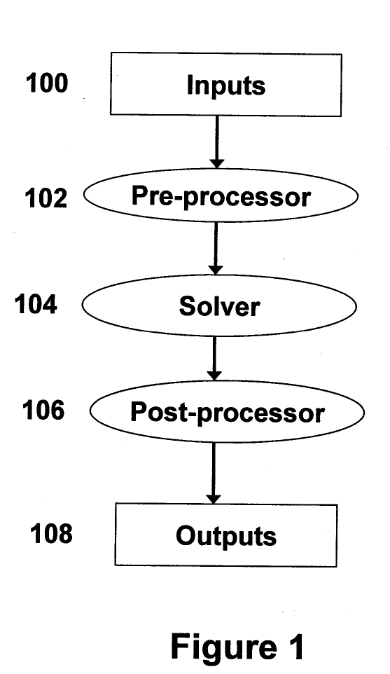

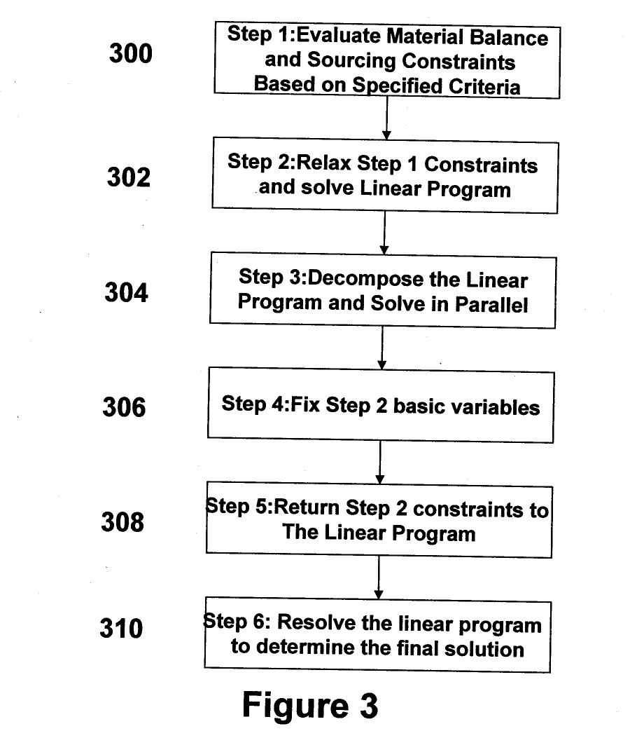

With regard to the general flow of linear programming applications illustrated in FIG. 1, the current invention illustrated in FIG. 3 relates to the solver illustrated in step 104. The method provides for improved computational efficiency and opportunity for parallel processing of parts of the linear program.

The present invention has been implemented on an IBM P690 server with AFS for data storage and using the AIX operating system. The steps for implementing the present invention are preferably programmed in C/C++. It should be understood by those of ordinary skill in the art, however, that the representative invention is not limited to the above implementation and is independent of the computer/system architecture. Accordingly, the present invention may equally be implemented on other computing platforms, programming languages and operating systems, and also may be hardwired into a circuit or other computational component.

Thus, as shown above, the invention provides a method and system for solving a linear program having constraints in a production planning system. The invention first determines which of the constraints can be temporarily relaxed based on stocking point criteria. The stocking point criteria relates to time dependent stocking points that include part numbers, locations of parts identified by the part numbers, and the time periods when the parts will be available. The invention relaxes the constraints that can be relaxed and decomposes the linear program into smaller independent linear programs. The invention initially solves the smaller independent linear programs with relaxed constraints (simultaneously in parallel) to produce an initial solution. Next, the invention replaces variables in the linear program with constants based on this initial solution. After this, the invention restores the material balance and sourcing constraints and finally solves (re-solves) the linear program using the constants and with all constraints in place to obtain a complete solution of the linear program.

The invention provides substantial runtime improvement. Large-scale production planning problems such as those at the central division planning level can pose serious problems in terms of runtime. The faster the application is able to run, the larger the number of scenarios that planners are able to review in order to determine an optimal division build plan to commit. For some production models instances, the invention has resulted in order of magnitude improvements in runtime (e.g., for one production model it reduced runtime from 13,201 to 933 seconds on an IBM Regatta p690).

While the invention has been described in terms of the preferred embodiments, those skilled in the art will recognize that the invention can be practiced with modification within the spirit and scope of the appended claims.

1. A method for decomposing a linear program comprising:
relaxing material balance and sourcing constraints of said linear program based on stocking point criteria;
initially solving the linear program with relaxed material balance and sourcing constraints to produce an initial solution;
replacing variables in said linear program with constants based on said initial solution;
restoring said material balance and sourcing constraints; and
finally solving the linear program using said constants and with all constraints in place to obtain a complete solution of said linear program.

2. The method in claim 1, further comprising, before initially solving said linear program, decomposing said linear program into smaller independent linear programs, wherein said process of initially solving said linear program solves said smaller independent linear programs simultaneously in parallel.

3. The method in claim 1, further comprising selecting material balance and sourcing constraints that are associated with the least complex parts within bills-of-materials used by said linear program as said relaxed material balance and sourcing constraints.

4. The method in claim 1, further comprising selecting material balance and sourcing constraints that are associated with parts that have supply availability and lack capacity constraints as said relaxed material balance and sourcing constraints.

5. The method in claim 1, further comprising selecting material balance and sourcing constraints that are associated with parts that are available during the planning horizon of said linear program as said relaxed material balance and sourcing constraints.

6. The method in claim 5, wherein said planning horizon includes an initial planning horizon, shipping lead time, and manufacturing cycle time.

7. The method in claim 1, wherein said stocking point criteria relates to time dependent stocking points comprising part numbers, locations of parts identified by said part numbers, and the time periods when said parts will be available.

8. A method for solving a linear program having constraints in a production planning system, said method comprising:
determining which of said constraints can be temporarily relaxed;
relaxing selected constraints of said linear program based on said determining process;
decomposing said linear program into smaller independent linear programs;
initially solving said smaller independent linear program with relaxed constraints to produce an initial solution;
replacing variables in said linear program with constants based on said initial solution;
restoring said material balance and sourcing constraints; and
finally solving said linear program using said constants and with all constraints in place to obtain a complete solution of said linear program.

9. The method in claim 8, wherein said process of initially solving said smaller independent linear programs solves said smaller independent linear programs simultaneously in parallel.

10. The method in claim 8, wherein said determining process identifies constraints that are associated with the least complex parts within bills-of-materials used by said linear program as said constraints that can be temporarily relaxed.

11. The method in claim 8, wherein said determining process identifies constraints that are associated with parts that have supply availability and lack capacity constraints as said constraints that can be temporarily relaxed.

12. The method in claim 8, wherein said determining process identifies constraints that are associated with parts that are available during the planning horizon of said linear program as said constraints that can be temporarily relaxed.

13. The method in claim 12, wherein said planning horizon includes an initial planning horizon, shipping lead time, and manufacturing cycle time.

14. The method in claim 8, wherein said determining process is based on stocking point criteria.

15. A method for solving a linear program having constraints in a production planning system, said method comprising:
determining which of said constraints can be temporarily relaxed based on stocking point criteria that relates to time dependent stocking points comprising part numbers, locations of parts identified by said part numbers, and the time periods when said parts will be available;
relaxing selected constraints of said linear program based on said determining process;
decomposing said linear program into smaller independent linear programs;
initially solving said smaller independent linear program with relaxed constraints to produce an initial solution;
replacing variables in said linear program with constants based on said initial solution;
restoring said material balance and sourcing constraints; and
finally solving the linear program using said constants and with all constraints in place to obtain a complete solution of said linear program.

16. The method in claim 15, wherein said process of initially solving said smaller independent linear programs solves said smaller independent linear programs simultaneously in parallel.

17. The method in claim 15, wherein said determining process identifies constraints that are associated with the least complex parts within bills-of-materials used by said linear program as said constraints that can be temporarily relaxed.

18. The method in claim 15, wherein said determining process identifies constraints that are associated with parts that have supply availability and lack capacity constraints as said constraints that can be temporarily relaxed.

19. The method in claim 15, wherein said determining process identifies constraints that are associated with parts that are available during the planning horizon of said linear program as said constraints that can be temporarily relaxed.

20. The method in claim 19, wherein said planning horizon includes an initial planning horizon, shipping lead time, and manufacturing cycle time.

21. A program storage device readable by machine, tangibly embodying a program of instructions executable by the machine to perform a method for solving a linear program having constraints in a production planning system, said method comprising:
determining which of said constraints can be temporarily relaxed;
relaxing selected constraints of said linear program based on said determining process;
decomposing said linear program into smaller independent linear programs;
initially solving said smaller independent linear program with relaxed constraints to produce an initial solution;
replacing variables in said linear program with constants based on said initial solution;
restoring said material balance and sourcing constraints; and
finally solving said linear program using said constants and with all constraints in place to obtain a complete solution of said linear program.
